(19) United States
(12) Patent Application Publication
(10) Pub. No.: US 2016/0093433 A1
(43) Pub. Date: Mar. 31, 2016

(54) NON-CONTACT POWER TRANSMITTER, ELECTRONIC DEVICE ON WHICH NON-CONTACT POWER TRANSMITTER IS MOUNTED AND METHOD OF MANUFACTURING NON-CONTACT POWER TRANSMITTER

(71) Applicant: Seiko Instruments Inc., Chiba-shi (JP)

(72) Inventors: Kiyohito ENDOU, Chiba-shi (JP); Teruo EBIHARA, Chiba-shi (JP); Masafumi HOSHINO, Chiba-shi (JP)

(21) Appl. No.: 14/865,865

(22) Filed: Sep. 25, 2015

(30) Foreign Application Priority Data
Sep. 29, 2014 (JP) 2014-198912

(51) Int. Cl. H01F 38/14; H01F 41/04; H01F 27/28

(52) U.S. Cl. CPC H01F 38/14; H01F 27/2823; H01F 41/04

(57) ABSTRACT

To provide a small non-contact power transmitter capable of securing the power transmission distance even when positional deviation occurs between a power transmission coil and a power receiving coil.

### RELATED APPLICATIONS

This application claims priority under 35 U.S.C. §119 to Japanese Patent Application No. 2014-198912 filed on Sep. 29, 2014, the entire contents of which is hereby incorporated by reference.

### BACKGROUND OF THE INVENTION

1. Field of the Invention

The present invention relates to a non-contact power transmitter, an electronic device on which the non-contact power transmitter is mounted and a method of manufacturing the non-contact power transmitter.

2. Description of the Related Art

In recent years, miniaturization and performance of parts are remarkably improved, and miniaturization of boards due to high integration and high-density packaging of semiconductor devices enables further miniaturization of electronic devices. Moreover, due to the supply of small-sized and high-capacity secondary batteries, electronic devices on which such batteries are mounted are rapidly becoming popular as a portable device or an ultra-small portable device the place of use of which is not restricted.

Concerning the ultra-small portable device, a non-contact power transmission technique capable of supplying power without a terminal and without a physical connection attracts attention.

The non-contact power transmitter introduced to the market now mainly supplies power to the secondary battery built in a cordless telephone, a cellular phone and a smart phone, which is large in size of the device as well as in the power to be supplied, which is several hundred mW to several W.

A primary coil (hereinafter referred to as a power transmission coil) provided in a charger, namely, a power transmission device and a secondary coil (referred to as a power receiving coil) provided in a power receiving device as a device to be charged are not coils with a small size and a small diameter at all with respect to outer shapes of current small portable devices.

In the power transmission performed by arranging the devices at relative positions of respective coils provided in the power transmission device and the receiving device of the non-contact power transmitter, there are many problems such as relative positional relationship of above, below, right and left of both coils, restriction in coil size even in a shape dimension of a casing which houses the coil, and restriction in transmission efficiency of power (hereinafter referred to as power transmission efficiency) in accordance with the coil size, therefore, the introduction to the small portable devices tends to be avoided.

In a non-contact power transmitter described in JP-A-10-12468 (Patent Document 1), a rod-shaped core 118 is arranged in an air core part of a power transmission coil, and a flat power transmission coil 116 and a power receiving coil 112 are used, thereby allowing a power receiving side member 111 to face a power transmission side member 117 in a flat-plane state as shown in FIG. 12. Moreover, Patent Document 1 presents that the magnetic coupling force between the power transmission coil and the power receiving coil is improved by concentrating the interlinkage magnetic flux generated in the power transmission coil 116 by the rod-shaped core 118 to thereby obtain high power transmission efficiency.

The relation between a diameter φG of the air core part of the power transmission coil 116 and a diameter φH of an air core part of the power receiving coil 112 is φG<φH, therefore, a positional deviation value of both coils allowable when the power transmission coil 116 faces the power receiving coil 112 can be expanded.

As a result, the relaxation in positioning accuracy between the power receiving device and the power transmission device largely contributes to the expansion of the degree of freedom in designing the casing of a portable device or the like in which the non-contact power transmitter is built.

Next, a non-contact power transmitter described in WO1999/027603 (Patent Document 2) presents that the highest power transmission efficiency can be obtained when outer shapes of the power transmission coil and the power receiving coil have approximately the same diameter, namely, a ratio between an outer diameter of the power transmission coil and an outer diameter of the power receiving coil is set to 0.7 to 1.3, and further, a ratio between an outer diameter and an inner diameter in both power transmission and receiving coils is set to 0.3 to 0.7.

Furthermore, Patent Document 2 presents that, when the deviation occurs in upper and lower arrangement positions of the power transmission and power receiving coils, relaxation in positioning accuracy in a deviation amount 1 mm can be realized by increasing the diameter of any one of air core parts of both power transmission and power receiving coils by 1 mm, and further, rapid charging to the secondary battery of 90% or more with respect to a power receiving rate obtained when the power is received at a reference position can be realized even when the positional deviation occurs in this range.

### SUMMARY OF THE INVENTION

However, when the non-contact power transmitter is built in a small portable device such as a Bluetooth canal-type earphones or a music reproduction device, the power receiving coil of the power receiving device housed in the small portable device is naturally required to be small in size and diameter. Moreover, the transmission coil of the transmission device always has to adopt approximately the same diameter. As the power receiving coil and the power transmission coil become small in size and diameter, and the magnetic coupling force between the both is reduced, it is difficult to extend the transmission distance and the transmission power is reduced, which makes the power transmitter inefficient as a system.

The shortage of the magnetic coupling force due to the small-diameter coils causes problems that the positional deviation allowable amount is too small to secure the power transmission distance necessary for use in the case where positional deviation of above, below, right or left of the facing surfaces of the power transmission coil and the power receiving coil occurs.

In view of the above, an object of the present invention is to provide a small non-contact power transmitter capable of securing the power transmission distance necessary for use even when positional deviation occurs between the power transmission coil and the power receiving coil.

According to an embodiment of the present invention, there is provided a non-contact power transmitter including a primary coil provided in a transmission-side member, to which the power is added, and a secondary coil provided in a receiving-side member, which receives the power, in which the secondary coil positioned in an axial direction of the primary coil in facing flat surfaces of the transmission-side member and the receiving-side member performs non-contact power transmission in a magnetic field generated by the primary coil, in which the primary coil has a magnetic substance on a coil surface which is opposite to a surface facing the secondary coil, and the secondary coil has a magnetic substance on a coil surface which is opposite to a surface facing the primary coil, and a relative ratio between an outer shape or an outer diameter of the secondary coil and an outer shape or an outer diameter of the primary coil is 0.7 or less to 0.3 or more.

According to the above, it is possible to provide the small non-contact power transmitter capable of securing the power transmission distance necessary for use even when positional deviation occurs between the power transmission coil and the power receiving coil.

In the non-contact power transmitter according to the embodiment of the present invention, the magnetic substance bonded to the coil surface of the primary coil which is opposite to the surface facing the secondary coil and the magnetic substance bonded to the coil surface of the secondary coil which is opposite to the surface facing the primary coil may have a thin-film sheet shape which can be plastically deformed, the sheet-shaped magnetic substance bonded to the primary coil may have transmission-side magnetic substance bending flange portions formed in a flange shape so as to protrude from an edge of the primary coil by a thickness dimension of the primary coil, and the sheet-shaped magnetic substance bonded to the secondary coil may have receiving-side magnetic substance bending flange portions formed in a flange shape so as to protrude from an edge of the secondary coil by a thickness dimension of the secondary coil.

According to the above, it is possible to secure a longer power transmission distance even when positional deviation occurs between the power transmission coil and the power receiving coil.

Also in the non-contact power transmitter according to the embodiment of the present invention, the transmission-side magnetic substance bending flange portions may be bent along a side surface of the primary coil, the receiving-side magnetic substance bending flange portions may be bent along a side surface of the secondary coil, and the primary coil and the secondary coil may be formed so that respective flange portions are bent along coil side surfaces to cover the side surfaces.

According to the above, it is possible to secure a longer power transmission distance even when positional deviation occurs between the power transmission coil and the power receiving coil.

The non-contact power transmitter according to the embodiment of the present invention may further include at least any one of the transmission-side member in which a concave part with a thickness dimension of the primary coil is formed in the sheet-shaped magnetic substance bonded to the primary coil, the concave part is formed to have the same outer-shape dimension as the primary coil so that the primary coil is buried and wrapped, and flange portions are formed in the entire circumference of the primary coil, and the receiving-side member in which a concave part with a thickness dimension of the secondary coil is formed in the sheet-shaped magnetic substance bonded to the secondary coil, the concave part is formed to have the same outer-shape dimension as the secondary coil so that the secondary coil is buried and wrapped, and flange portions are formed in the entire circumference of the secondary coil.

According to the above, it is possible to secure a longer power transmission distance even when positional deviation occurs between the power transmission coil and the power receiving coil.

Also in the non-contact power transmitter according to the embodiment of the present invention, a relative ratio between an inner diameter of an air core part in the center of the secondary coil and an inner diameter of an air core part of the primary coil may be 0.6 or more to 1.0 or less.

According to the above, it is possible to secure a longer power transmission distance even when positional deviation occurs between the power transmission coil and the power receiving coil.

Also in the non-contact power transmitter according to the embodiment of the present invention, the air core part of the secondary coil may be filled with a magnetic substance.

According to the above, it is possible to secure a longer power transmission distance even when positional deviation occurs between the power transmission coil and the power receiving coil.

Also according to an embodiment of the present invention, there is provided a method of manufacturing a non-contact power transmitter including a primary coil provided in a transmission-side member, to which the power is added, and a secondary coil provided in a receiving-side member, which receives the power, in which the secondary coil positioned in an axial direction of the primary coil in facing flat surfaces of the transmission-side member and the receiving-side member performs non-contact power transmission in a magnetic field generated by the primary coil, which includes the steps of bonding a thin-film sheet shaped magnetic substance which can be plastically deformed to a coil surface of the primary coil which is opposite to a surface facing the secondary coil and bonding a thin-film sheet shaped magnetic substance which can be plastically deformed to a coil surface of the secondary coil which is opposite to a surface facing the primary coil.

According to the above, it is possible to manufacture the small non-contact power transmitter capable of securing the power transmission distance necessary for use even when positional deviation occurs between the power transmission coil and the power receiving coil.

The method of manufacturing the non-contact power transmitter according to the embodiment of the present invention may further include the steps of bending flange portions of the plastically-deformable magnetic substance included in the primary coil along a side surface of the primary coil and bending flange portions of the plastically-deformable magnetic substance included in the secondary coil along a side surface of the secondary coil.

According to the above, it is possible to manufacture the small non-contact power transmitter capable of securing a longer power transmission distance even when positional deviation occurs between the power transmission coil and the power receiving coil.

Also according to an embodiment of the present invention, there is provided a method of manufacturing a non-contact power transmitter including a primary coil provided in a transmission-side member, to which the power is added, and a secondary coil provided in a receiving-side member, which receives the power, in which the secondary coil positioned in an axial direction of the primary coil in facing flat surfaces of the transmission-side member and the receiving-side member performs non-contact power transmission in a magnetic field generated by the primary coil, in which a magnetic substance bonded to a coil surface of the primary coil which is opposite to a surface facing the secondary coil and a magnetic substance bonded to a coil surface of the secondary coil which is opposite to a surface facing the primary coil are included, and the magnetic substances bonded to the primary coil and the secondary coil have a thin-film sheet shape which can be plastically deformed, which includes the steps of forming a concave part in the sheet-shaped magnetic substance bonded to the primary coil to have an outer shape dimension which is the same as a thickness dimension of the primary coil and forming flange portions at an outer periphery of the concave part over the entire circumference of the primary coil by forming the concave part so that the primary coil is buried and wrapped.

According to the above, it is possible to manufacture the small non-contact power transmitter capable of securing the power transmission distance necessary for use even when positional deviation occurs between the power transmission coil and the power receiving coil.

Also according to an embodiment of the present invention, there is provided a method of manufacturing a non-contact power transmitter including a primary coil provided in a transmission-side member, to which the power is added, and a secondary coil provided in a receiving-side member, which receives the power, in which the secondary coil positioned in an axial direction of the primary coil in facing flat surfaces of the transmission-side member and the receiving-side member performs non-contact power transmission in a magnetic field generated by the primary coil, in which a magnetic substance bonded to a coil surface of the primary coil which is opposite to a surface facing the secondary coil and a magnetic substance bonded to a coil surface of the secondary coil which is opposite to a surface facing the primary coil are included, and the magnetic substances bonded to the primary coil and the secondary coil have a thin-film sheet shape which can be plastically deformed, which includes the steps of forming a concave part in the sheet-shaped magnetic substance bonded to the secondary coil to have an outer shape dimension which is the same as a thickness dimension of the secondary coil and forming flange portions at an outer periphery of the concave part over the entire circumference of the secondary coil by forming the concave part so that the secondary coil is buried and wrapped.

According to the above, it is possible to manufacture the small non-contact power transmitter capable of securing the power transmission distance necessary for use even when positional deviation occurs between the power transmission coil and the power receiving coil.

Also according to an embodiment of the present invention, there is provided an electronic device on which the above non-contact power transmitter is mounted.

According to the above, it is possible to provide the small electronic device capable of securing the power transmission distance necessary for use even when positional deviation occurs between the power transmission coil and the power receiving coil.

According to the present invention, the relative ratio between the outer shape or the outer diameter of the secondary coil and the outer shape or the outer diameter of the primary coil is set to 0.7 or less to 0.3 or more, thereby providing the small non-contact power transmitter capable of securing the power transmission distance necessary for use even when positional deviation occurs between the power transmission coil and the power receiving coil.

### BRIEF DESCRIPTION OF THE DRAWINGS

FIG. 1 is a structural view of a non-contact power transmitter according to a first embodiment;

FIG. 2 is a graph showing the relation between magnetic materials and variations in impedances of coil characteristics;

FIG. 3 is a structural view of a non-contact power transmitter according to a second embodiment;

FIG. 4 is a view showing the measurement of positional deviation amount/inclination/power transmission distance according to the second embodiment;

FIG. 5 is a graph showing the relation between the power transmission distance (mm) by wireless power transmission and the power receiving rate (%) in the ratio 0.67;

FIG. 6 is a graph showing the relation between the power transmission distance (mm) by wireless power transmission and the power receiving rate (%) in the ratio 0.45;

FIGS. 7A and 7B are structural views of a non-contact power transmitter according to a fourth embodiment;

FIGS. 8A to 8C are views showing other shapes of coils with flanges;

FIGS. 9A to 9D are conceptual views of magnetic closed circuits at the time of using the coils with flanges;

FIGS. 10A and 10B are first process charts of forming coils with flanges;

FIGS. 11A and 11B are second process charts of forming coils with flanges; and

FIG. 12 is a structural view of a non-contact power transmitter according to a related-art embodiment.

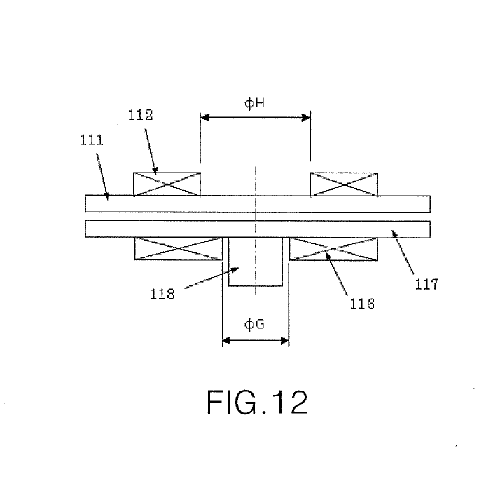

### DETAILED DESCRIPTION OF THE PREFERRED EMBODIMENTS

Hereinafter, embodiments of the present invention will be explained with reference to the drawings.

### First Embodiment

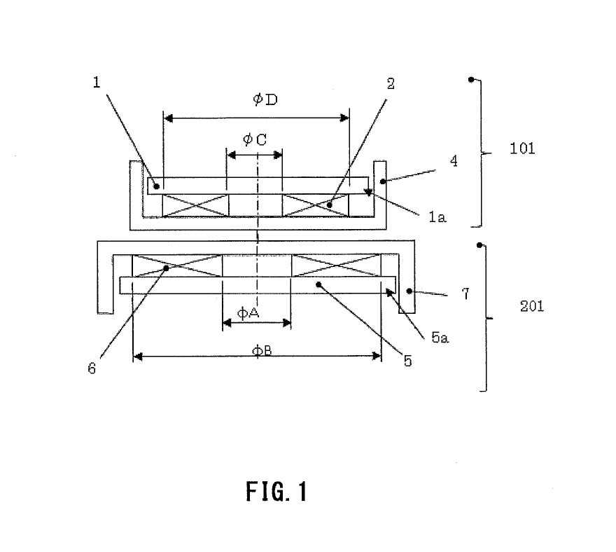

A non-contact power transmitter according to a first embodiment of the present invention will be explained with reference to FIG. 1. FIG. 1 is a structural view of the non-contact power transmitter according to the first embodiment.

The non-contact power transmitter is configured by two devices which are a power receiving device 101 and a power transmission device 201.

The power receiving device 101 is configured by housing a power receiving coil 2 (actual dimensions: outer diameter φD8.13 mm, inner diameter φ6.0 mm) as a secondary coil having a thickness of 1.0 mm formed of a conductive member which is adhered to a magnetic substance 1 formed to have an outer diameter of φ10.0 mm and a thickness of 0.5 mm inside a power receiving side casing 4 formed of a casing forming material of an insulator having a thickness of 0.5 mm.

The power transmission device 201 is configured by housing a power transmission coil 6 (actual dimensions: outer diameter φB, inner diameter φ6.0 mm) as a primary coil having a thickness of 1.0 mm formed of a conductive member which is adhered to a magnetic substance 5 formed to have an outer diameter of φB+2.0 mm and a thickness of 0.5 mm inside a power transmission side body 7 formed of a casing forming material of an insulator having a thickness of 0.5 mm. In this case, the magnetic substance 1 in the power receiving side is formed to have an outer diameter of 10.0 mm with a flange portion 1a so as to protrude 1.0 mm larger than φD of the power receiving side coil 2. The magnetic substance 5 in the power transmission side is formed to have the outer diameter of φB+2.0 mm with a flange portion 5a so as to protrude 1.0 mm larger than φB of the power transmission side coil 6.

Results obtained by changing the outer diameter of the power transmission coil 6 and checking the power transmission distance in the power receiving device 101 with a charge amount 30 mA are shown in Table 1. The inner diameter of the power transmission coil 6 was fixed and the inner diameter ratio of the power transmission coil 6 to the power receiving coil 2 was also fixed at 1.0.

TABLE 1
Power receivable distance between φ8.13 mm power receiving coil and respective power transmission coils

| Design value | | | Measured value | | | Power |
|---|---|---|---|---|---|---|
| | Power | | Power | Power | | transmission |
| Power | transmission | Outer | receiving | transmission | Outer | distance measured |
| receiving coil | coil | diameter ratio | coil | coil | diameter ratio | value |
| 8 mm | 20 mm | 0.40 | 8.13 mm | 20.35 mm | 0.40 | 2.3 mm |
| 8 mm | 22 mm | 0.36 | 8.13 mm | 21.96 mm | 0.37 | 3.1 mm |
| 8 mm | 24 mm | 0.33 | 8.13 mm | 24.32 mm | 0.33 | 3.8 mm |

According to Table 1, it is found that the distance over which power can be transmitted is increased as the diameter of the power transmission coil is increased. Also according to the above, it confirmed that the power transmission distance is extended by making the diameter of the power transmission coil larger than the diameter of the power receiving coil.

A ratio between the outer diameter φB of the power transmission coil and the outer diameter φD of the power receiving coil used in the first embodiment was 0.33 or more to 0.40 or less. The relation between the outer diameter of the power transmission coil and the outer diameter of the power receiving coil is φB>φD. The small non-contact power transmitter capable of securing the power transmission distance can be realized by selecting the above relation between the outer diameter of the power receiving coil and the outer diameter of the power transmission coil and the above outer diameter ratio.

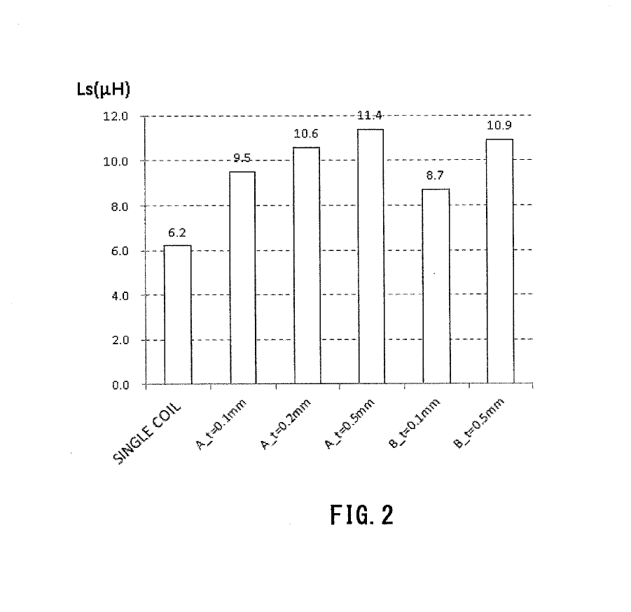

The variation of inductance values obtained when using the magnetic substance will be explained with reference to FIG. 2. FIG. 2 is a graph showing the relation between magnetic materials and variations in impedances of coil characteristics. In the drawing, the inductance value of the single coil is compared with inductance values of coils obtained by adhering magnetic substances of 0.1 mm to 0.5 mm to the same coil. Two types of magnetic substances which are A-type and B-type having different characteristic values were used. It can be seen from FIG. 2 that the inductance value can be increased by adhering the magnetic substances to the coil even when the inductance value of the single coil is 6.2 μH. It is also found that the inductance value tends to be increased by increasing the thickness both in the A-type and B-type magnetic bodies having different characteristic values. Accordingly, the effect of expanding the power transmission distance can be expected in the shape and the method of using the magnetic substances.

The magnetic substance having a lower magnetic permeability than that of the A-type magnetic substance is used in the first embodiment.

(The Relation in Magnetic Permeability is: The Magnetic Substance Used in the First Embodiment<A Type<B Type)

### Second Embodiment

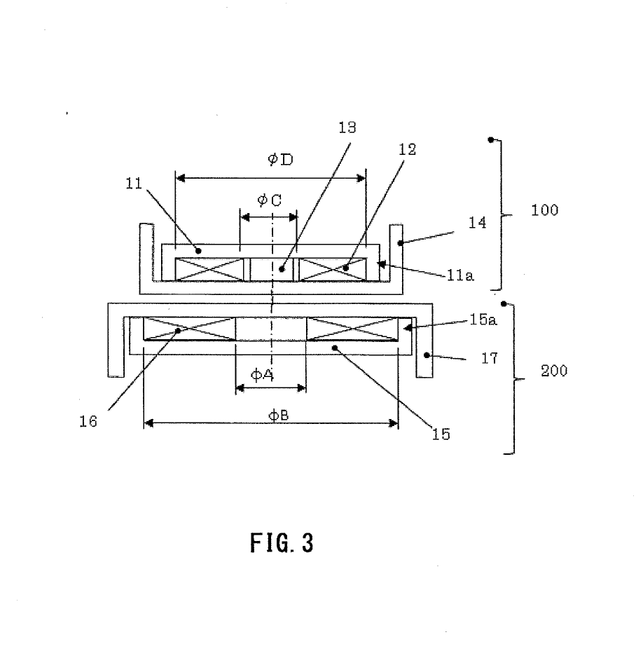

A non-contact power transmitter according to a second embodiment of the present invention will be explained with reference to FIG. 3. In the embodiment, a power transmission coil 16 having an inner diameter φA of 6.06 mm and an outer diameter φB of 20.83 mm and a power receiving coil 12 having an inner diameter φC of 4.02 mm and an outer diameter φD of 14.03 mm are used on the assumption that a device has a power receiving ability of 100 mA. As ratios of outer shape dimensions between the power receiving coil 12 and the power transmission coil 16, an outer diameter ratio (φD14.03 mm/φB20.83 mm)=0.67 and an inner diameter ratio (φC4.02 mm/φA6.06 mm)=0.63.

A receiving-side magnetic substance 11 includes a receiving-side magnetic substance bending part 11a so as to wrap a side surface part of the power receiving coil 12. The receiving-side magnetic substance bending part 11a is fabricated so as to protrude in a flange shape by a thickness of the power receiving coil 12, namely, 1.0 mm from an outer peripheral part of the power receiving coil 12 so that an outer diameter size thereof is equal to the outer shape φD+2.0 mm of the power receiving coil 12, and further, the receiving-side magnetic substance bending part 11a is formed by bending an end part of the flange shape so as to face a power transmission device 200.

A transmission-side magnetic substance 15 includes a transmission-side magnetic substance bending portion 15a so as to wrap a side surface part of the power transmission coil 16. The transmission-side magnetic substance bending portion 15a is fabricated so as to protrude in a flange shape by a thickness of the power transmission coil 16, namely, 1.0 mm from an outer peripheral part of the power transmission coil 16 so that an outer diameter size thereof is equal to the outer shape φB+2.0 mm of the power transmission coil 16, and further, the transmission-side magnetic substance bending part 15a is formed by bending an end part of the flange shape so as to face a power receiving device 100.

The both coils are attached to a transmission-side casing 17 and a receiving-side casing 14 which are formed of casing forming materials of 0.5 mm in thickness, and a transmission distance is set to 1 mm when the power receiving coil 12 and the power transmission coil 16 face each other so as to sandwich the forming materials of the both casings.

Next, an air core part having an inner diameter φC in the power receiving coil 12 is filled with a magnetic substance made of the same material as the receiving-side magnetic substance 11 to thereby form a core 13. In this case, the magnetic substance of the core 13 is formed in a circular shape with the same diameter as the inner diameter φC of the power receiving coil with a thickness of 0.5 mm, and two magnetic substances are stacked and bonded to be a thickness of the power receiving coil 12 (the thickness of the power receiving coil is 1 mm in the present invention) to fill the inner diameter of the air core part of the power receiving coil. As the receiving-side magnetic substance 11 bonded to the power receiving coil 12, the magnetic substance made of the same material as the magnetic substance used in the core 13 with a thickness of 0.1 mm is used. The magnetic substance having favorable cost and a good performance is used in the embodiment, which is A-type of t=0.1 mm from constraints on product specifications.

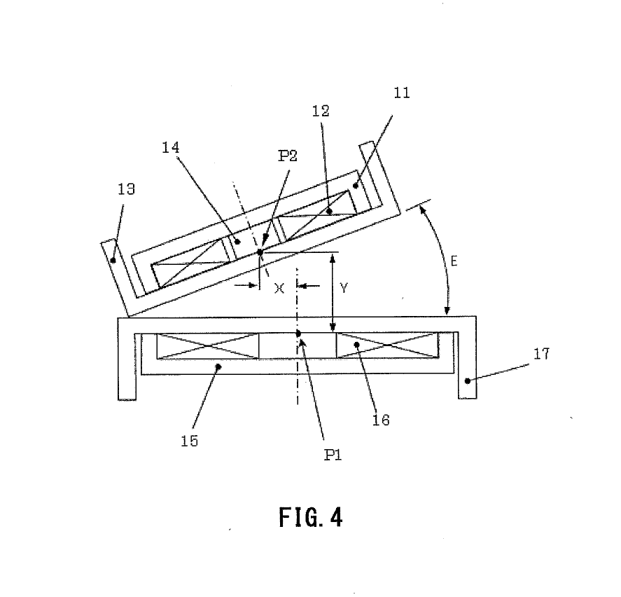

Measurement was performed by changing the distance between the coils as the power transmission distance (hereinafter referred to as a distance between coils) in the non-contact power transmitter having the above structure according to the second embodiment. The details will be explained with reference to FIG. 4.

FIG. 4 is a view showing the measurement of positional deviation amount/inclination/power transmission distance in the second embodiment. The power receiving rates were checked in the case where the distance (center deviation amount of coils) X between respective coil centers of the power receiving coil 12 and the power transmission coil 16 in the horizontal direction was changed from 0 mm to 8 mm, in the case where the distance between coils (hereinafter referred to as a distance between coils) Y as the distance in the vertical direction from respective coil centers of the power receiving coil 12 and the power transmission coil 16 was changed from 1 mm to 6 mm, and in the case where the inclination (a coil attack angle) E of the power receiving coil 12 with respect to the power transmission coil 16 was changed between 0 degrees and 15 degrees.

First, the center deviation amount X of coils and the distance between coils Y were changed when the coil attack angle E is 0 degrees as Condition 1, and power receiving rates in respective conditions were measured by setting a measured power receiving rate obtained when X=0 mm and Y=1 mm as a reference power receiving rate of 100%.

Then, the center deviation amount X of coils and the distance between coils Y were changed when the coil attack angle E is 15 degrees as Condition 2, and power receiving rates in respective conditions were measured by setting the measured power receiving rate obtained when X=0 mm and Y=1 mm in Condition 1 as a reference power receiving rate of 100%. The results obtained by measuring power receiving rates in respective conditions are shown in Table 2.

TABLE 2
a) Relation of power transmission distance in secondary coil-downsizing ratio; 0.67

| | | Coil center deviation; X | | | | | | | | |
|---|---|---|---|---|---|---|---|---|---|---|
| | | attack angle E = 0 deg | | | | | | | | |
| Charging rate | | 0 mm | 1 mm | 2 mm | 3 mm | 4 mm | 5 mm | 6 mm | 7 mm | 8 mm |
| Distance | 1 mm | 100% | 100% | 100% | 99% | 99% | 98% | 98% | 97% | |
| between coils; Y | 2 mm | 100% | 100% | 99% | 98% | 98% | 98% | 97% | 97% | |
| | 3 mm | 99% | 99% | 99% | 97% | 97% | | | | |
| | 4 mm | 97% | 98% | 97% | 96% | 96% | | | | |
| | 5 mm | 97% | 97% | 97% | | | | | | |
| | 6 mm | | | | | | | | | |

b) Relation of power transmission distance in secondary coil-downsizing ratio; 0.67

| | Coil center deviation; X | | | | | | | | |
|---|---|---|---|---|---|---|---|---|---|
| | attack angle E = 0 deg | | | | | | | | |
| Charging rate | 0 mm | 1 mm | 2 mm | 3 mm | 4 mm | 5 mm | 6 mm | 7 mm | 8 mm |

| | | | | | | |
|---|---|---|---|---|---|---|
| Distance | 2.8 | 99% | 99% | 98% | 98% | 97% |
| between | 3.8 | 98% | 98% | 98% | 98% | |
| coils; Y | 4.8 | 98% | 98% | 98% | 97% | |
| | 5.8 | 96% | | | | |
| | 6.8 | | | | | |

The measurement results in Condition 1 are shown in a) and the measurement results in Condition 2 are shown in b).

In Condition 1, even when the center deviation amount X between both coils was the maximum 7 mm and the distance between coils Y was the maximum 5 mm in the case where the coil attack angle E is 0 degrees, the power receiving rates of 95% or more could be obtained with respect to the reference power receiving rate.

Next, in Condition 2, even when the center deviation amount X between both coils was the maximum 4 mm and the distance between coils Y was the maximum 5.8 mm in the case where the coil attack angle E was 15 degrees, the power receiving rates of 95% or more could be obtained with respect to the reference power receiving rate when the coil attack angle E=0 degrees.

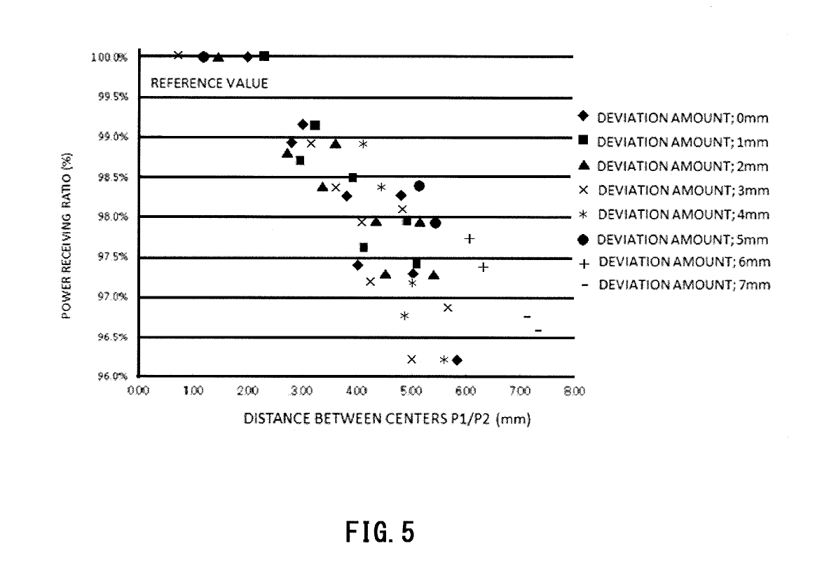

Next, the correlation between the power receiving rate and the distance between coil centers in the case where the power receiving rate measured when the center deviation amount X is 0 mm and the distance between coils Y is 1 mm in the condition that the coil attack angle E is 0 degrees shown in FIG. 4 is set as the reference power receiving rate 100% will be explained with reference to FIG. 5. The distance between coil centers indicates a straight-line distance from a coil center P1 of the power transmission coil to a coil center P2 of the power receiving coil.

FIG. 5 is a graph showing the relation between the power transmission distance (mm) by wireless power transmission and the power receiving rate (%) in the ratio 0.67.

According to the graph, it is found that the power receiving ratio is reduced as the distance between the centers P1 and P2 is increased. Though the power receiving rate does not reach 60% when the positional deviation of centers between the power transmission coil and the power receiving coil is 2 mm in related art, it is found that the power receiving rate is 95% or more even when the distance between coil centers is 5 mm or more in the present invention.

As the results of the second embodiment and the first embodiment are taken into account, it is found that the small non-contact power transmitter capable of securing the power transmission distance can be realized when the ratio between the outer diameter φB of the transmission coil and the outer diameter φD of the power receiving coil is 0.33 or more to 0.67 or less as well as the relation between the outer diameter of the power transmission coil and the outer diameter of the power receiving coil is φB>φD.

It is also found that the small non-contact power transmitter capable of further securing the power transmission distance can be realized when the ratio between the inner diameter φA of the air core part of the power transmission coil and the inner diameter φC of the air core part of the power receiving coil is 0.6 or more to 1.0 or less as well as the relation between the inner diameter φA of the air core part of the power transmission coil and the inner diameter φC of the air core part of the power receiving coil is φA≧φC.

Moreover, the magnetic concentration can be realized by filling the air core part of the power receiving coil 12 formed to have the inner diameter φC with the magnetic substance of the core 13 to thereby increase the power transmission distance even in the power receiving coil 12 which is small in size and diameter, which realizes the small non-contact power transmitter capable of further securing the power transmission distance.

The transmission-side magnetic substance 15 of the power transmission device is formed to have the outer diameter larger than the outer diameter φB of the power transmission coil 16 as a conductive part by a thickness t1 of the power transmission coil 16, namely, to have the outer diameter of φB+2×t1, and edges of the power transmission side magnetic substance 15 which are extra added are bent so as to wrap the power transmission coil 16 as well as the power receiving magnetic substance 11 of the power receiving device is formed to have the outer diameter larger than the outer diameter φD of the power receiving coil 12 as a conductive part by a thickness t2 of the power receiving coil 12, namely, to have the outer diameter of φD+2×t2, and edges of the power receiving side magnetic substance 11 which are extra added are bent so as to wrap the power receiving coil 12, therefore, a closed magnetic circuit is formed and the power transmission distance can be extended even in the power receiving coil which is small in size and diameter.

### Third Embodiment

A non-contact power transmitter according to a third embodiment of the present invention will be explained. In the third embodiment, a power receiving coil 12 having an outer diameter φD of 9.45 mm mounted on the power receiving device 100 is used and the power transmission device 200 used in the second embodiment is used on the assumption that the device having the same structure as the second embodiment and a power receiving ability of 30 mA. Accordingly, as ratios of outer shape dimensions between the power receiving coil 12 and the power transmission coil 16, an outer diameter ratio (φD9.45 mm/φB20.83 mm) 0.45 and an inner diameter ratio (φC3.93 mm/φA6.06 mm)=0.65.

The center deviation amount X of coils and the distance between coils Y were changed when the coil attack angle E is 0 degrees as Condition 3, and power receiving rates in respective conditions were measured by setting a measured power receiving rate obtained when X=0 mm and Y=1 mm as a reference power receiving rate of 100%.

Then, the center deviation amount X of coils and the distance between coils Y were changed when the coil attack angle E is 15 degrees as Condition 4, and power receiving rates in respective conditions were measured by setting the measured power receiving rate obtained when X=0 mm and Y=1 mm in Condition 3 as a reference power receiving rate of 100%. The result obtained by measuring power receiving rates in respective conditions are shown in Table 3.

TABLE 3
a) Relation of power transmission distance in secondary coil-downsizing ratio; 0.45

| | | Coil center deviation; X | | | | | | | | |
|---|---|---|---|---|---|---|---|---|---|---|
| | | attack angle E = 0 deg | | | | | | | | |
| Charging rate | | 0 mm | 1 mm | 2 mm | 3 mm | 4 mm | 5 mm | 6 mm | 7 mm | 8 mm |
| Distance | 1 mm | 100% | 100% | 100% | 100% | 99% | 99% | 98% | 98% | |
| between coils; Y | 2 mm | 99% | 99% | 99% | 99% | 99% | 99% | 98% | | |
| | 3 mm | 99% | 99% | 99% | 99% | 99% | 98% | | | |
| | 4 mm | 98% | 98% | 98% | 98% | 98% | 97% | | | |
| | 5 mm | 98% | 98% | 98% | 97% | | | | | |
| | 6 mm | | | | | | | | | |

b) Relation of power transmission distance in secondary coil-downsizing ratio; 0.45

| | Coil center deviation; X | | | | | | | | |
|---|---|---|---|---|---|---|---|---|---|
| | attack angle E = 15 deg | | | | | | | | |
| Charging rate | 0 mm | 1 mm | 2 mm | 3 mm | 4 mm | 5 mm | 6 mm | 7 mm | 8 mm |

| | | | | | | | |
|---|---|---|---|---|---|---|---|
| Distance | 2.3 mm | 99% | 99% | 99% | 98% | 98% | 98% |
| between | 3.3 mm | 98% | 98% | 98% | 98% | 98% | 98% |
| coils; Y | 4.3 mm | 98% | 98% | 98% | 98% | 98% | |
| | 5.3 mm | 98% | 98% | 98% | | | |
| | 6.3 mm | | | | | | |

The measurement results in Condition 3 are shown in a) and the measurement results in Condition 4 are shown in b).

In Condition 3, even when the center deviation amount X between both coils is the maximum 7 mm and the distance between coils Y is the maximum 5 mm in the case where the coil attack angle E is 0 degrees, the power receiving rates of 95% or more could be obtained with respect to the reference power receiving rate.

Next, in Condition 4, even when the center deviation amount X between both coils was the maximum 5 mm and the distance between coils Y was the maximum 5.3 mm in the case where the coil attack angle E was 15 degrees, the power receiving rates of 95% or more could be obtained with respect to the reference power receiving rate when the coil attack angle E=0 degrees.

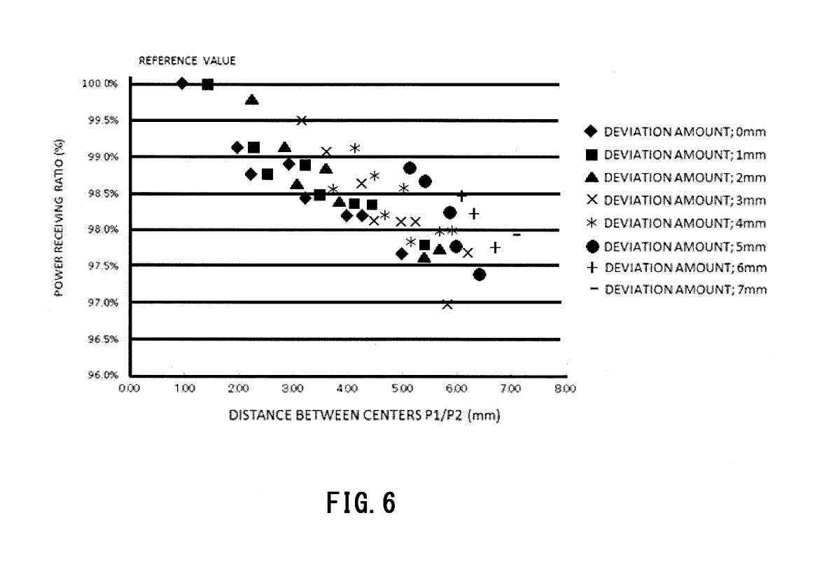

Next, the correlation between the power receiving rate and the distance between coil centers in the case where the power receiving rate measured when the center deviation amount X is 0 mm and the distance between coils Y is 1 mm in the condition that the coil attack angle E is 0 degrees shown in FIG. 4 is set as the reference power receiving rate 100% will be explained with reference to FIG. 6. FIG. 6 is a graph showing the relation between the power transmission distance (mm) by wireless power transmission and the power receiving rate (%) in the ratio 0.45.

According to the graph, it is found that the power receiving ratio is reduced as the distance between centers P1 and P2 is increased in the same manner as FIG. 5. Though the power receiving rate does not reach 60% when the positional deviation of centers between the power transmission coil and the power receiving coil is 2 mm in related art, it is found that the power receiving rate is 97% or more even when the distance between coil centers is 5 mm or more in the present invention.

Furthermore, a closed magnetic circuit is formed as long as the power receiving coil device exists over the power transmission coil device by forming the devices so that both the power transmission coil and the power receiving coil are wrapped by the magnetic substances, thereby securing the power receiving rate of 95% or more when the distance between coils is within 5 mm.

### Fourth Embodiment

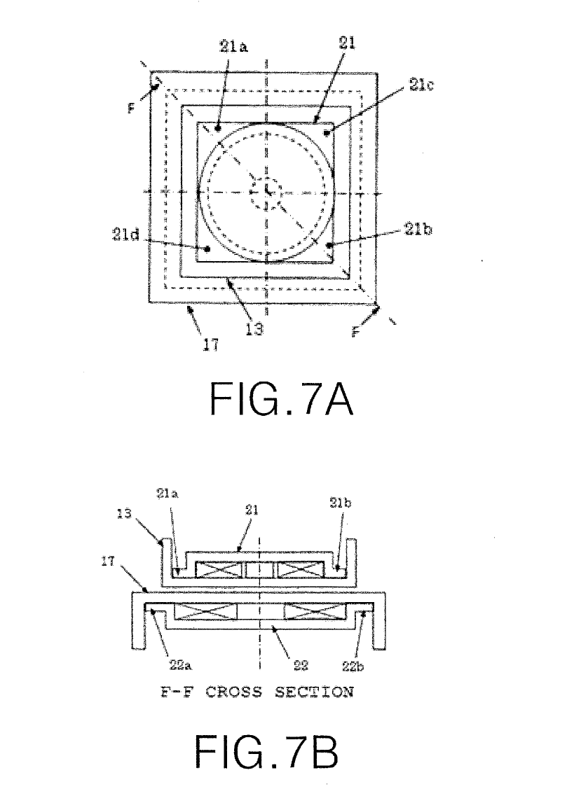

A non-contact power transmitter according to a fourth embodiment of the present invention will be explained with reference to FIGS. 7A and 7B. FIGS. 7A and 7B are structural views of the non-contact power transmitter according to the fourth embodiment.

The device has almost the same structure as the second embodiment. The device differs from the second embodiment in a point that a transmission-side magnetic substance 22 has transmission-side magnetic substance bending flange portions 22a to 22d as shown in FIG. 7 in addition to the transmission-side magnetic substance bending portion 15a arranged so as to wrap the side surface part of the power transmission coil 16 and a point that a receiving-side magnetic substance 21 has receiving-side magnetic substance bending flange portions 21a to 21d in addition to the receiving side magnetic substance bending part 11a arranged so as to wrap the side surface part of the power receiving coil 12. In more detail, the device differs in a point that a square magnetic substance in which one edge has an outer diameter length (diameter) of the power receiving coil 12 having the circular shape is used as the receiving-side magnetic substance 21 and a point that a square magnetic substance in which one edge has the outer diameter length of the power transmission coil 16 is used as the power transmission magnetic substance 22.

The center deviation amount X of coils and the distance between coils Y were changed when the coil attack angle E is 0 degrees in the same manner as Condition 1 of the second embodiment, and power receiving rates in respective conditions were measured by setting the measured power receiving rate obtained when X=0 mm and Y=1 mm in Condition 1 as a reference power receiving rate of 100%. The result is shown in FIG. 4.

TABLE 4
Relation of power transmission distance by device with
flange portions in secondary coil-downsizing ratio; 0.67

| | | Coil center deviation; | | | | | | | | |
|---|---|---|---|---|---|---|---|---|---|---|
| | | X attack angle E = 0 deg | | | | | | | | |
| Charging rate | | 0 mm | 1 mm | 2 mm | 3 mm | 4 mm | 5 mm | 6 mm | 7 mm | 8 mm |
| Distance | 1 mm | 100% | 100% | 100% | 100% | 99% | 99% | 98% | 98% | 97% |
| between coils; Y | 2 mm | 100% | 100% | 100% | 100% | 99% | 98% | 98% | 97% | |
| | 3 mm | 99% | 99% | 99% | 99% | 98% | 97% | 96% | | |
| | 4 mm | 98% | 98% | 97% | 97% | 97% | 96% | | | |
| | 5 mm | 97% | 97% | 97% | 96% | | | | | |
| | 6 mm | 97% | 96% | | | | | | | |

In the fourth embodiment, even when the center deviation amount X between both coils is the maximum 8 mm and the distance between coils Y is the maximum 6 mm in the case where the coil attack angle E is 0 degrees, the power receiving rates of 95% or more could be obtained with respect to the reference power receiving rate. In the fourth embodiment in which the flange portions are included, a longer power transmission distance could be obtained as compared with the second embodiment in which measurement was performed in the same conditions.

The receiving-side magnetic substance bending flange portions 21a to 21d cover the side surface of the power receiving coil 12 so as to sink the receiving-side magnetic substance 21 along the power receiving coil 12 as shown in a F-F cross section and are arranged over the receiving side casing 14 so that four corners of the receiving-side magnetic substance 21 are parallel to a surface of the power receiving coil 12 contacting the receiving side casing 14. According to the structure, the magnetic coupling force can be further improved.

The transmission-side magnetic substance bending flange portions 22a to 22d also cover the side surface of the power transmission coil 16 so as to sink the transmission-side magnetic substance 22 along the power transmission coil 16 in the same manner as the receiving-side magnetic substance bending flange portions 21a to 21d and are arranged over the transmission side casing 17 so that four corners of the transmission-side magnetic substance 22 are parallel to a surface of the power transmission coil 16 contacting the transmission side casing 17. According to the structure, the magnetic coupling force can be further improved.

As a result, it is configured from Table 4 that, the receiving-side magnetic substance bending flange portions 21a to 21d of the receiving-side magnetic substance 21 are close to the transmission-side magnetic substance bending flange portions 22a to 22d of the transmission-side magnetic substance 22 so as to face each other, thereby improving the magnetic coupling, relaxing the positioning accuracy of coils without reducing the power receiving rate in the same manner as the first embodiment and increasing the facing distance between the power receiving coil and the power transmission coil.

As described above, the non-contact power transmitter according to the present invention can be mounted on a small portable device as the positioning accuracy of coils can be relaxed without reducing the power receiving rate even when the power transmission coil is increased in size and the power receiving coil is reduced in size, and the facing distance between the power receiving coil and the power transmission coil can be increased, and further, the non-contact power transmitter can be adopted without impairing the design of the small portable device.

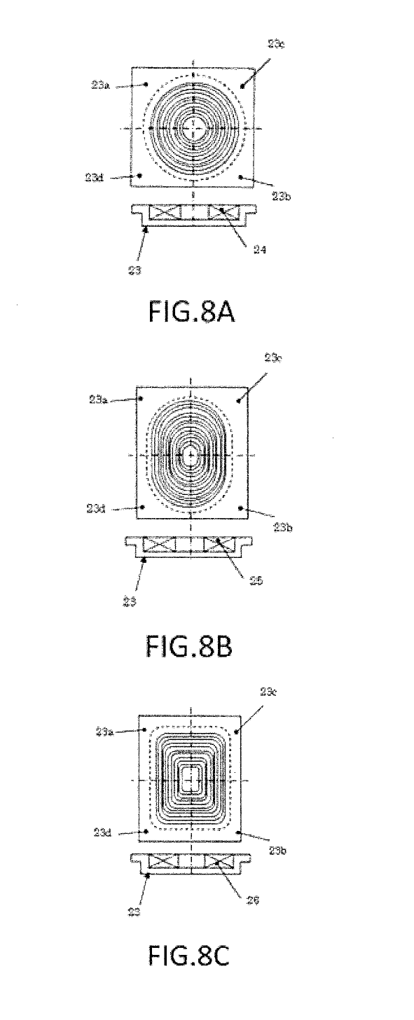

In the present embodiments, the circular power transmission coil and the circular power transmission coil which are wound, and magnetic substances accompanied by these coils have been explained as examples, however the coils are not limited to the circular shape. Other examples will be explained with reference to FIGS. 8A to 8C. FIGS. 8A to 8C are views showing other shapes of coils with flanges. The flange portions of the coil device can be formed in the entire coil as shown in FIG. 8A. The same advantages can be obtained by applying the structure of the present invention to a transmission coil and a receiving coil having an elliptical shape and magnetic substances accompanied by the coils shown in FIG. 8B, a transmission coil and a receiving coil having a square shape and magnetic substances accompanied by the coils shown in FIG. 8C or structures of integral devices obtained by combining the power transmission device 200 and the power receiving device 100 having the above shapes.

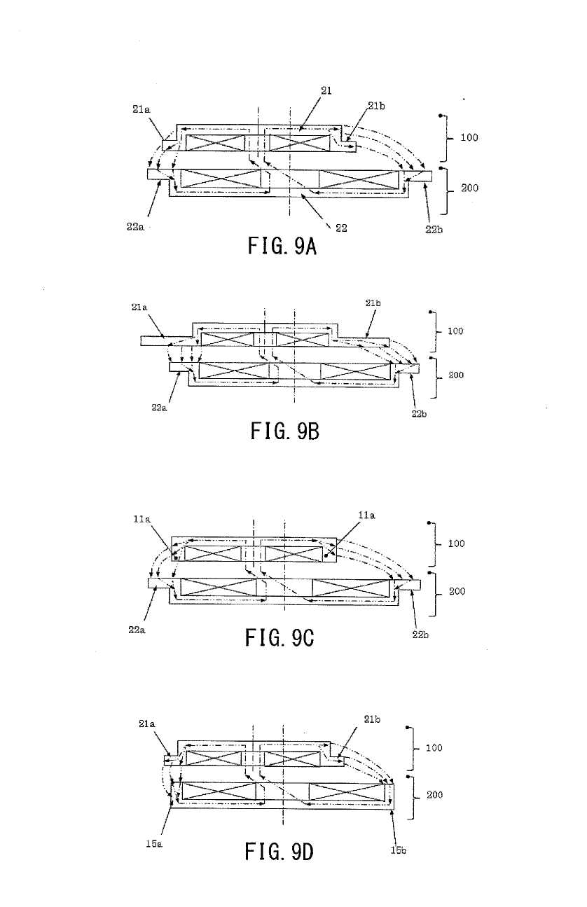

Magnetic coupling closed circuits formed when the positional deviation occurs in the power transmission and receiving devices due to the difference in the flange shape will be explained with reference to FIGS. 9A to 9D. FIGS. 9A to 9D are conceptual views of magnetic closed circuits at the time of using the coils with flanges.

FIG. 9A is a model explained in the fourth embodiment. FIG. 9B shows a device structure in which a diameter from an end of the flange portion 22a to an end of the flange portion 22b of the power transmission device 200 is set to be the same as a diameter from an end of the flange portion 21a to an end of the flange portion 21b of the power receiving device 100. Therefore, the magnetic closed circuit can be formed easily as the flange portions 21a and the flange portion 21b are wider than the flange portion 22a and the flange portion 22b, and the positional deviation can be allowed by the wider flange portion 21a and the flange portion 21b even when the positional deviation occurs in the power receiving device 100 and the power transmission device 200 as shown in the drawing.

FIG. 9C and FIG. 9D show shapes in which flange portions are formed in edges of the magnetic substance in any of the power transmission device 100 and the power receiving device 100. According to the structure, the effective magnetic coupling force can be obtained by forming the flange portions 21a and 21b in the magnetic substance of the power receiving device or by forming the flange portions 22a and 22b in the magnetic substance of the power transmission device in at least one of the power transmission device and the power receiving device.

As described above, the flange portions are formed around the power transmission coil 16 so as to sink the transmission coil 16 in the rectangle-shaped transmission-side magnetic substance 15 in which one edge length of the rectangle-shaped transmission-side magnetic substance 15 is longer than the diameter of the power transmission coil 16 as well as the flange portions are also formed around the power receiving coil 12 so as to sink the power receiving coil 12 in the rectangle-shaped receiving-side magnetic substance 11 in which one edge length of the rectangle-shaped receiving-side magnetic substance 11 is longer than the diameter of the power receiving coil 12, thereby allowing both flanges portions which are the ends of the receiving-side magnetic substance 11 and the ends of the transmission-side magnetic substance 15 to be close to each other regardless of the coil shape, as a result, the highly effective closed magnetic circuit is formed and the power transmission distance can be increased even in the power receiving coil 12 which is small in size and diameter.

### (Manufacturing Processes)

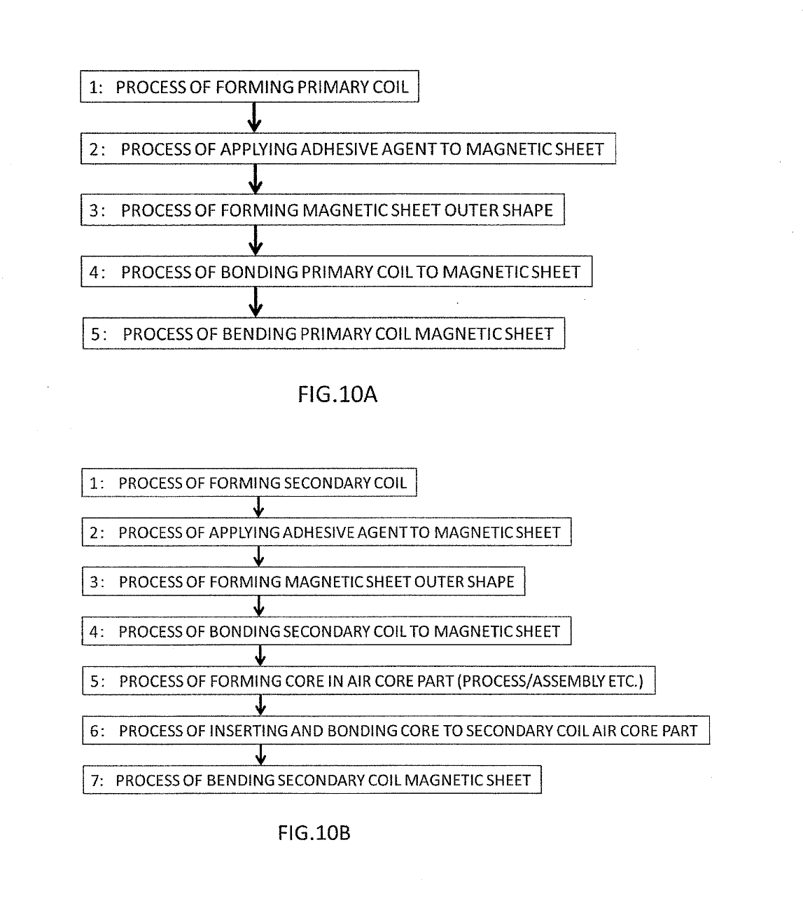

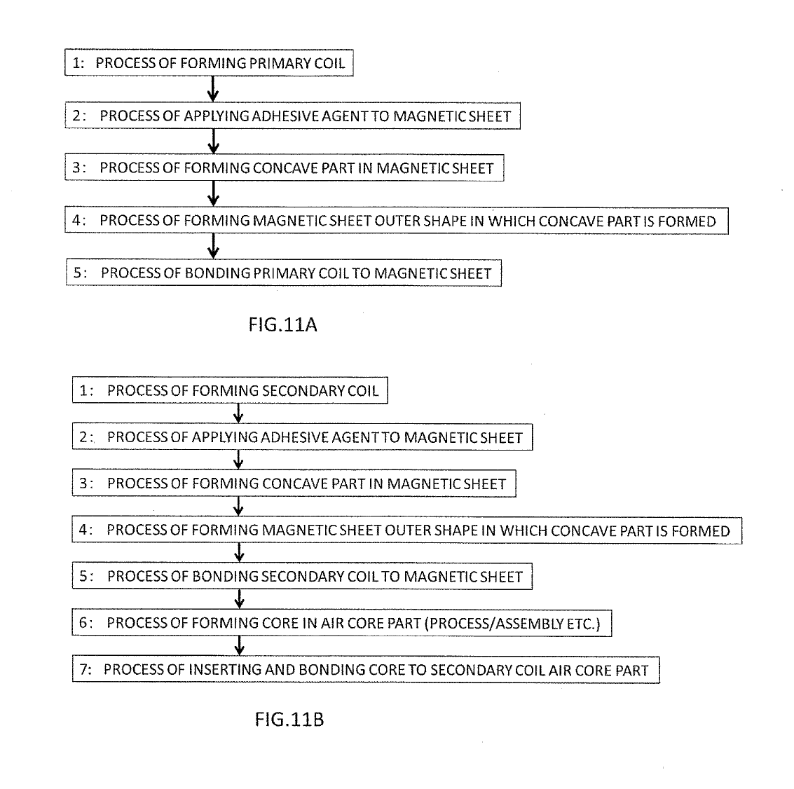

Next, manufacturing processes of the present invention will be explained with reference to FIG. 10 and FIG. 11. FIGS. 10A and 10B are first process charts of forming coils with flanges, showing manufacturing processes of the device using the primary coil as the power transmission coil and the secondary coil as the power receiving coil in the power transmission device 200 and the power receiving device 100.

The manufacturing processes of the power transmission device 201 according to the first embodiment continue until a process of bonding the primary coil to the magnetic substance in the fourth process of FIG. 10A, and the manufacturing processes of the power receiving device 101 continue until a process of bonding the secondary coil to the magnetic substance in the fourth process of FIG. 10B.

The processes will be explained by citing the second embodiment as an example with reference to FIGS. 10A and 10B.

First, manufacturing processes of the power transmission device including the power transmission coil according to the first to third embodiments will be explained with reference to FIG. 10A.

In the first process, the coil is formed by winding a thin wire made of a conductive material (a process of forming the primary coil).

In the second process, a rubber-based or silicon-based adhesive agent, or a plasticity-type, thermosetting-type or photosetting-type adhesive is applied to the magnetic substance to which the coil is bonded (a process of applying an adhesive agent to the magnetic sheet).

The rubber-based adhesive agent is used as the adhesive agent, and a sheet-type magnetic substance (hereinafter referred to as a magnetic sheet) which can be plastically deformed is used in this case.

In the third process, the magnetic sheet to which the rubber-based adhesive agent is applied is punched by a die for forming the magnetic sheet in a predetermined shape with respect to the outer shape of the power transmission coil (a process of forming a magnetic sheet outer shape).

In the fourth process, the magnetic sheet formed by punching is bonded to the primary coil formed in the first process on the same center (a process of bonding the primary coil to the magnetic sheet). The power transmission device 201 according to the first embodiment is completed when the power transmission coil unit fabricated until this process is mounted on the transmission-side casing 7.

In the fifth process, the coil is bonded on the magnetic sheet formed by the punching, and a protruding magnetic sheet is bent to be deformed along the coil side surface (a process of bending the primary coil magnetic sheet). The power transmission device 200 according to the second and third embodiments is completed by being mounted on the transmission side casing 7 in this process.

Next, manufacturing processes of the power receiving device including the power receiving coil according to the first to third embodiments will be explained with reference to FIG. 10B.

In the first process, the coil is formed by winding a thin wire made of a conductive material (a process of forming the secondary coil).

In the second process, a rubber-based or silicon-based adhesive agent, or a plasticity-type, thermosetting-type or photosetting-type adhesive is applied to the magnetic substance to which the coil is bonded (a process of applying an adhesive agent to the magnetic sheet).

The rubber-based adhesive agent is used as the adhesive agent, and a sheet-type magnetic substance (hereinafter referred to as a magnetic sheet) which can be plastically deformed is used in this case.

In the third process, the magnetic sheet to which the rubber-based adhesive agent is applied is punched by a die for forming the magnetic sheet in a predetermined shape with respect to the outer shape of the power receiving coil (a process of forming a magnetic sheet outer shape).

In the fourth process, the magnetic substance 11 of the magnetic sheet formed by punching is bonded to the power receiving coil 12 formed in the first process on the same center (a process of bonding the secondary coil to the magnetic sheet). The power receiving device 101 according to the first embodiment is completed when the coil unit of the power receiving coil 2 and the magnetic substance 1 fabricated until this process is mounted on the receiving-side casing 4.

In the fifth process, the magnetic sheet to which the adhesive agent is applied and processed in the third process or the magnetic sheet having a different thickness and the same material passed through the second process and the third process is punched in a diameter which can be inserted into the air core part φC for inserting the core 13 into the air core part φC of the power receiving coil 12, and core parts formed by punching are stacked and bonded so as to be the same thickness as the thickness of the power receiving coil 12 (a process of forming the core in the air core part).

In the sixth process, in the magnetic substance 11 and the power receiving coil 12 formed by punching and assembled by bonding in the fourth process, the core 13 having the same material as the magnetic substance 11 is inserted into the air core part of the power receiving coil 12 and bonded (a process of inserting and bonding the core to the secondary coil air core part).

In the seventh process, the magnetic substance protruding around the coil unit formed by the magnetic substance 11 and the power receiving coil 12 to which the core 13 is inserted and bonded is bent to be deformed along the coil side surface (a process of bending the secondary coil magnetic sheet). The power receiving device 100 according to the second and third embodiments is completed by being mounted on the receiving side casing 14 in this process.

Next, the processes will be explained by citing the fourth embodiment as an example with reference to FIGS. 11A and 11B.

FIGS. 11A and 11B are second process charts of forming coils with flanges, showing manufacturing processes of the device using the primary coil as the power transmission coil and the secondary coil as the power receiving coil in the power transmission device 200 and the power receiving device 100 with flanges.

First, manufacturing processes of the power transmission device 200 including the power transmission coil according to the fourth embodiment will be explained with reference to FIG. 11A.

In the first process, the coil is formed by winding a thin wire made of a conductive material (a process of forming the primary coil).

In the second process, a rubber-based or silicon-based adhesive agent, or a plasticity-type, thermosetting-type or photosetting-type adhesive is applied to the magnetic substance (a process of applying an adhesive agent to the magnetic sheet). The rubber-based adhesive agent is used as the adhesive agent, and a sheet-type magnetic substance which can be plastically deformed is used in this case.

In the third process, a concave part is formed with a depth dimension equal to the thickness of the power transmission coil 16 so that the magnetic sheet 15 to which the rubber-based adhesive agent is applied has a predetermined shape corresponding to the outer shape of the power transmission coil (a process of forming a concave part in the magnetic sheet).

In the fourth process, the magnetic substance in which the concave part is formed with the depth dimension equal to the thickness of the power transmission coil 16 is punched to have a predetermined shape (a process of forming a magnetic sheet outer shape in which the concave part is formed). At the time of outer-shape punching in the above process, punching is performed by a metal die or the like so that the magnetic substance is larger than the outer shape of the power transmission coil 16, thereby forming the flange portions 22a to 22d in the magnetic substance 22 of the power transmission device 200.

In the fifth process, the transmission coil 16 is inserted and bonded to the concave part of the magnetic substance 22 in the power transmission device's side which is punched in the fourth process (a process of bonding the primary coil to the magnetic sheet). The power transmission device 200 according to the fourth embodiment is completed when being mounted on the transmission-side casing 17 in this process.

Next, manufacturing processes of the power receiving device 100 including the power receiving coil according to the fourth embodiment will be explained with reference to FIG. 11B.

In the first process, the coil is formed by winding a thin wire made of a conductive material (a process of forming the secondary coil).

In the second process, a rubber-based or silicon-based adhesive agent, or a plasticity-type, thermosetting-type or photosetting-type adhesive is applied to the magnetic substance (a process of applying an adhesive agent to a magnetic sheet). The rubber-based adhesive agent is used as the adhesive agent, and a sheet-type magnetic substance which can be plastically deformed is used in this case.

In the third process, a concave part is formed with a depth dimension equal to the thickness of the power receiving coil 12 so that the magnetic sheet 21 to which the rubber-based adhesive agent is applied has a predetermined shape corresponding to the outer shape of the power receiving coil (a process of forming a concave part in the magnetic sheet).

In the fourth process, the magnetic substance in which the concave part is formed with the depth dimension equal to the thickness of the power receiving coil 12 is punched to have a predetermined shape (a process of forming a magnetic sheet outer shape in which the concave part is formed). At the time of outer-shape punching in the above process, punching is performed by a metal die or the like so that the magnetic substance is larger than the outer shape of the power receiving coil 12, thereby forming the flange portions 21a to 21d in the magnetic substance 21 of the power receiving device 100.

In the fifth process, the power receiving coil 12 is inserted and bonded to the concave part of the magnetic substance 21 in the power receiving device's side which is punched in the fourth process (a process of bonding the primary coil to the magnetic sheet).

In the sixth process, the magnetic sheet to which the adhesive agent is applied and processed in the third process or the magnetic sheet having a different thickness and the same material is punched in a diameter which can be inserted into the air core part φC for inserting the core 13 into the air core part φC of the power receiving coil 12, and core parts formed by punching are stacked and bonded so as to be the same thickness as the thickness of the power receiving coil 12 (a process of forming the core in an air core part).

In the seventh process, in the coil unit formed by the magnetic substance 11 and the power receiving coil 12 which are assembled by bonding in the sixth process, the core 13 having the same material as the magnetic substance 11 is inserted and bonded to the air core part of the power receiving coil 12 (a process of inserting and bonding the core to the secondary coil air core part). The power receiving device 100 according to the fourth embodiment is completed by being mounted on the receiving side casing 14 in this process.

Lastly, as the present process charts only include necessary processes, it is not prescribed that the entire device is manufactured by these processes.

Also concerning the manufacturing order of respective processes, it is not particularly prescribed whether the magnetic substance is processed after manufacturing respective coils or the coils are manufactured after processing the magnetic substance.

What is claimed is:

1. A non-contact power transmitter including a primary coil provided in a transmission-side member, to which the power is added, and a secondary coil provided in a receiving-side member, which receives the power, in which the secondary coil positioned in an axial direction of the primary coil in facing flat surfaces of the transmission-side member and the receiving-side member performs non-contact power transmission in a magnetic field generated by the primary coil,
wherein the primary coil has a magnetic substance on a coil surface which is opposite to a surface facing the secondary coil, and the secondary coil has a magnetic substance on a coil surface which is opposite to a surface facing the primary coil, and
a relative ratio between an outer shape or an outer diameter of the secondary coil and an outer shape or an outer diameter of the primary coil is 0.7 or less to 0.3 or more.

2. The non-contact power transmitter according to claim 1,
wherein the magnetic substance bonded to the coil surface of the primary coil which is opposite to the surface facing the secondary coil and the magnetic substance bonded to the coil surface of the secondary coil which is opposite to the surface facing the primary coil have a thin-film sheet shape which can be plastically deformed,
the sheet-shaped magnetic substance bonded to the primary coil has transmission-side magnetic substance bending flange portions formed in a flange shape so as to protrude from an edge of the primary coil by a thickness dimension of the primary coil, and
the sheet-shaped magnetic substance bonded to the secondary coil has receiving-side magnetic substance bending flange portions formed in a flange shape so as to protrude from an edge of the secondary coil by a thickness dimension of the secondary coil.

3. The non-contact power transmitter according to claim 1,
wherein the transmission-side magnetic substance bending flange portions are bent along a side surface of the primary coil,
the receiving-side magnetic substance bending flange portions are bent along a side surface of the secondary coil, and
the primary coil and the secondary coil are formed so that respective flange portions are bent along coil side surfaces to cover the side surfaces.

4. The non-contact power transmitter according to claim 2, comprising at least any one of:
the transmission-side member in which a concave part with a thickness dimension of the primary coil is formed in the sheet-shaped magnetic substance bonded to the primary coil, the concave part is formed to have the same outer-shape dimension as the primary coil so that the primary coil is buried and wrapped, and flange portions are formed in the entire circumference of the primary coil, and
the receiving-side member in which a concave part with a thickness dimension of the secondary coil is formed in the sheet-shaped magnetic substance bonded to the secondary coil, the concave part is formed to have the same outer-shape dimension as the secondary coil so that the secondary coil is buried and wrapped, and flange portions are formed in the entire circumference of the secondary coil.

5. The non-contact power transmitter according to claim 1,
wherein a relative ratio between an inner diameter of an air core part in the center of the secondary coil and an inner diameter of an air core part of the primary coil is 0.6 or more to 1.0 or less.

6. The non-contact power transmitter according to claim 5,
wherein the air core part of the secondary coil is filled with a magnetic substance.

7. A method of manufacturing a non-contact power transmitter including a primary coil provided in a transmission-side member, to which the power is added, and a secondary coil provided in a receiving-side member, which receives the power, in which the secondary coil positioned in an axial direction of the primary coil in facing flat surfaces of the transmission-side member and the receiving-side member performs non-contact power transmission in a magnetic field generated by the primary coil, the method comprising the steps of:
bonding a thin-film sheet shaped magnetic substance which can be plastically deformed to a coil surface of the primary coil which is opposite to a surface facing the secondary coil; and
bonding a thin-film sheet shaped magnetic substance which can be plastically deformed to a coil surface of the secondary coil which is opposite to a surface facing the primary coil.

8. The method of manufacturing the non-contact power transmitter according to claim 7 further comprising the steps of:
bending flange portions of the plastically-deformable magnetic substance included in the primary coil along a side surface of the primary coil; and
bending flange portions of the plastically-deformable magnetic substance included in the secondary coil along a side surface of the secondary coil.

9. A method of manufacturing a non-contact power transmitter including a primary coil provided in a transmission-side member, to which the power is added, and a secondary coil provided in a receiving-side member, which receives the power, in which the secondary coil positioned in an axial direction of the primary coil in facing flat surfaces of the transmission-side member and the receiving-side member performs non-contact power transmission in a magnetic field generated by the primary coil,
wherein a magnetic substance bonded to a coil surface of the primary coil which is opposite to a surface facing the secondary coil and a magnetic substance bonded to a coil surface of the secondary coil which is opposite to a surface facing the primary coil are included, and
the magnetic substances bonded to the primary coil and the secondary coil have a thin-film sheet shape which can be plastically deformed, the method comprising the steps of:
forming a concave part in the sheet-shaped magnetic substance bonded to the primary coil to have an outer shape dimension which is the same as a thickness dimension of the primary coil; and
forming flange portions at an outer periphery of the concave part over the entire circumference of the primary coil by forming the concave part so that the primary coil is buried and wrapped.

10. A method of manufacturing a non-contact power transmitter including a primary coil provided in a transmission-side member, to which the power is added, and a secondary coil provided in a receiving-side member, which receives the power, in which the secondary coil positioned in an axial direction of the primary coil in facing flat surfaces of the transmission-side member and the receiving-side member performs non-contact power transmission in a magnetic field generated by the primary coil,
wherein a magnetic substance bonded to a coil surface of the primary coil which is opposite to a surface facing the secondary coil and a magnetic substance bonded to a coil surface of the secondary coil which is opposite to a surface facing the primary coil are included, and
the magnetic substances bonded to the primary coil and the secondary coil have a thin-film sheet shape which can be plastically deformed, the method comprising the steps of:
forming a concave part in the sheet-shaped magnetic substance bonded to the secondary coil to have an outer shape dimension which is the same as a thickness dimension of the secondary coil; and
forming flange portions at an outer periphery of the concave part over the entire circumference of the secondary coil by forming the concave part so that the secondary coil is buried and wrapped.

11. An electronic device on which the non-contact power transmitter according to claim 1 is mounted.
